(19) United States
(12) Patent Application Publication
(10) Pub. No.: US 2025/0177936 A1
(43) Pub. Date: Jun. 5, 2025

(54) Stirring Device

(71) Applicant: LG Energy Solution, Ltd., Seoul (KR)

(72) Inventors: Woong Ju Bang, Daejeon (KR); Jae Pil Koo, Daejeon (KR); Sung Jong Shin, Daejeon (KR); Jae Huoung Son, Daejeon (KR)

(73) Assignee: LG Energy Solution, Ltd., Seoul (KR)

(21) Appl. No.: 18/840,325

(22) PCT Filed: Jun. 29, 2023
(86) PCT No.: PCT/KR2023/009124

§ 371 Date: Aug. 21, 2024

(30) Foreign Application Priority Data
Jul. 1, 2022 (KR) 10-2022-0081377

(51) Int. Cl. B01F 35/11; B01F 27/2123; B01F 27/85; B01F 35/221

(52) U.S. Cl. CPC B01F 35/11; B01F 27/2123; B01F 27/85; B01F 35/2212; B01F 35/221422

(57) ABSTRACT

A stirring device includes a container, a cleaning liquid supply part for supplying a cleaning solution to the container, a first stirring part including a first stirring rod located inside the container, and having a suction passage provided inside the first stirring rod and a plurality of suction ports connecting the suction passage and the inner space of the container in a fluid movable manner and sucking the cleaning liquid in the container, a second stirring part including a second stirring rod located inside the container, and having a discharge passage provided inside the second stirring rod and a plurality of discharge ports connecting the discharge passage and the inner space of the container in a fluid movable manner, and a cleaning liquid circulation part connected to the suction passage and the discharge passage; and provided to supply the cleaning liquid introduced through the suction passage to the discharge passage.

### CROSS-REFERENCE TO RELATED APPLICATIONS

The present application is a national phase entry under 35 U.S.C. § 371 of International Application No. PCT/KR2023/009124, filed Jun. 29, 2023, published in Korean, which claims priority from Korean Patent Application No. 10-2022-0081377 filed Jul. 1, 2022, all of which are incorporated herein by reference in their entireties.

### FIELD OF THE INVENTION

The present invention relates to a stirring device, and more particularly, relates to a stirring device capable of stirring raw materials for a slurry during a mixing process and automatically cleaning the entire space of a container when cleaning the container.

### BACKGROUND OF THE INVENTION

Secondary batteries mean batteries capable of charging and discharging, unlike primary batteries that cannot be charged, and are widely used for power sources of electronic devices such as mobile phones and notebook computers, or electric vehicles, and the like.

A manufacturing process of a secondary battery comprises an electrode manufacturing process, an electrode assembly process, and a formation process.

The electrode manufacturing process is a process of manufacturing an electrode used in a secondary battery. The electrode manufacturing process comprises a mixing process, a slurry coating process, a drying process, a rolling process, a slitting process, and a notching process.

The mixing process of the electrode manufacturing process is a process of stirring slurry raw materials. In the mixing process, slurry raw materials are introduced into a container and stirred to form a slurry. The slurry raw materials include an active material, a conductive agent, a binder, and a solvent, and the like.

The mixing process is performed in a stirring device. After producing the same type of slurry in a certain amount, or before preparing a different type of slurry from the existing slurry, a cleaning operation for the container is performed.

FIG. 1 is a diagram for explaining a cleaning process of a container (11) according to the conventional technology.

The stirring device (10) comprises a container (11), a stirring rod (12), a stirring blade (13), and a stirring motor (14).

In general, the cleaning method of the container (11) performing the mixing process of the slurry is as follows.

A certain amount of cleaning liquid (W1) is introduced into the container (11). When the cleaning liquid (W1) is introduced into the container (11), the stirring rod (12) is rotated while the stirring motor (14) is operated. When the stirring rod (12) rotates, the cleaning liquid (W1) in the container (11) is stirred by the stirring blade (13) and cleans the lower space (A1) of the container (11) while forming vortexes.

The cleaning range of the container (11) is the range affected by the vortexes of the cleaning liquid (W1) when the stirring rod (12) rotates. Accordingly, even if the cleaning operation is repeatedly performed, the cleaning liquid (W1) does not reach the upper space (A2) of the container (11), thereby making it difficult to evenly clean the entire space of the container (11).

Accordingly, conventionally, the portion that the cleaning liquid (W1) does not reach when the cleaning liquid (W1) is stirred, mainly, the upper space (A2) of the container (11) is manually cleaned by a worker.

Upon cleaning the container (11) manually, the stirring device (10) is stopped. Accordingly, after the cleaning operation is completed, the stirring device (10) is restarted, but additional restart time is required in addition to the manual cleaning time.

In addition, the cleaning time required to clean the container (11) is irregular depending on the skill level of the worker. This may act as one factor that lowers the operational efficiency of the mixing process.

### BRIEF SUMMARY OF THE INVENTION

The present invention is intended to provide a stirring device capable of automatically cleaning the entire space of a container when cleaning the container.

In addition, the present invention is intended to provide a stirring device capable of cleaning the lower space of a container while a cleaning liquid in the container is stirred when the container is cleaned and cleaning the upper space of the container as the cleaning liquid in the container is sprayed into the upper space of the container while circulating a cleaning liquid circulation part.

A stirring device according to one example of the present invention comprises a container, a cleaning liquid supply part for supplying a cleaning liquid to the container, a first stirring part including a first stirring rod located inside the container, and having a suction passage provided inside the first stirring rod and a plurality of suction ports connecting the suction passage and the inner space of the container in a fluid movable manner and sucking the cleaning liquid in the container, a second stirring part including a second stirring rod located inside the container, and having a discharge passage provided inside the second stirring rod and a plurality of discharge ports connecting the discharge passage and the inner space of the container in a fluid movable manner, and a cleaning liquid circulation part connected to the suction passage and the discharge passage, respectively, and provided to supply the cleaning liquid introduced through the suction passage to the discharge passage.

Here, the plurality of suction ports may be located at a lower height than the plurality of discharge ports in the container.

The cleaning liquid circulation part may comprise a suction pipe connected to the suction passage, a discharge pipe connected to the discharge passage, and a circulation pump connected to the suction pipe and the discharge pipe, respectively.

The plurality of suction ports may be disposed apart from each other in the circumferential direction of the first stirring rod, and the suction passage may comprise a recovery line connected to a suction pipe of the cleaning liquid circulation part and extending along the central axis direction of the first stirring rod, and a recovery branch line branched from the recovery line to be connected to the plurality of suction ports.

In addition, the plurality of discharge ports may be disposed apart from each other along the circumferential direction of the second stirring rod, and the discharge passage may comprise a discharge line connected to a discharge pipe of the cleaning liquid circulation part and extending along the central axis direction of the second stirring rod, and a discharge branch line branched from the discharge line to be connected to the plurality of discharge ports.

The cleaning liquid supply part may comprise a cleaning liquid tank in which the cleaning liquid is stored, and a supply pump supplying the cleaning liquid in the cleaning liquid tank into the container.

The stirring device may further comprise a control part controlling the cleaning liquid supply part, the first and second stirring parts, and the cleaning liquid circulation part, wherein the control part may be provided so that it supplies the cleaning liquid into the container at a certain level through the cleaning liquid supply part, and then operates the cleaning liquid circulation part.

The control part may be provided to maintain a rotational speed of the first stirring rod lower than a rotational speed of the second stirring rod.

Then, the control part may be provided to operate the cleaning liquid circulation part while rotating the first stirring rod and the second stirring rod.

The cleaning liquid circulation part may further comprise a valve installed on the first stirring rod to open and close the suction ports, wherein the valve may be provided to open the suction ports upon operation of the circulation pump.

A stirring device according to another example of the present invention comprises a container, a cleaning liquid supply part for supplying a cleaning liquid to the container, a first stirring part including a first stirring rod located inside the container, and having a suction passage provided inside the first stirring rod and a plurality of suction ports connecting the suction passage and the inner space of the container in a fluid movable manner and sucking the cleaning liquid in the container, a plurality of second stirring parts each including a second stirring rod located inside the container, and having a discharge passage provided inside the second stirring rod and a plurality of discharge ports connecting the discharge passage and the inner space of the container in a fluid movable manner, and a cleaning liquid circulation part connected to the suction passage and the discharge passage, respectively, and provided to supply the cleaning liquid introduced through the suction passage to the discharge passage.

Here, the first stirring rod may be positioned in the center portion of the container, and the respective second stirring rods may be disposed apart from the first stirring rod at the same interval.

Then, the plurality of suction ports may be located at a lower height than the plurality of discharge ports in the container.

The cleaning liquid circulation part may comprise a suction pipe connected to the suction passage, a discharge pipe connected to the discharge passage, and a circulation pump connected to the suction pipe and the discharge pipe, respectively.

As described above, the stirring device related to at least one example of the present invention has the following effects.

When cleaning a container, the lower space of the container can be cleaned while the cleaning liquid in the container is stirred, and the upper space of the container can be cleaned while the cleaning liquid in the container is sprayed into the upper space of the container via the cleaning liquid circulation part. That is, the entire space of the container can be automatically cleaned through the cleaning liquid circulation part.

In addition, through cleaning automation of the container, it is possible to perform a mixing process of a slurry after quickly cleaning the container, so that the production efficiency of the slurry can be improved.

### BRIEF DESCRIPTION OF THE DRAWINGS

FIG. 1 is a diagram for explaining a cleaning process of a container according to the conventional technology.

FIG. 2 schematically illustrates a configuration diagram of a stirring device according to one example of the present invention.

FIG. 3 is a diagram for explaining a process in which a cleaning liquid is introduced into a container when a cleaning liquid supply part is operated in one example of the present invention.

FIG. 4 is a diagram for explaining a flow of a cleaning liquid when a cleaning liquid circulation part operates in one example of the present invention.

FIG. 5 is a diagram for explaining a flow of a cleaning liquid when a cleaning liquid circulation part operates together with first and second stirring parts in one example of the present invention.

FIG. 6(a) is a cross-sectional diagram of a first stirring part, and FIG. 6(b) is a schematic diagram for explaining a flow of a cleaning liquid flowing through a suction passage in the first stirring part when a cleaning liquid circulation part operates.

FIG. 7(a) is a cross-sectional diagram of A-A in FIG. 6(a), and FIG. 7(b) is a cross-sectional diagram of B-B in FIG. 6(a).

FIG. 8(a) is a cross-sectional diagram of a second stirring part, and FIG. 8(b) is a schematic diagram for explaining a flow of a cleaning liquid flowing through a discharge passage in the second stirring part when a cleaning liquid circulation part operates.

FIG. 9(a) is a cross-sectional diagram of C-C in FIG. 8(a), and FIG. 9(b) is a cross-sectional diagram of D-D in FIG. 8(a).

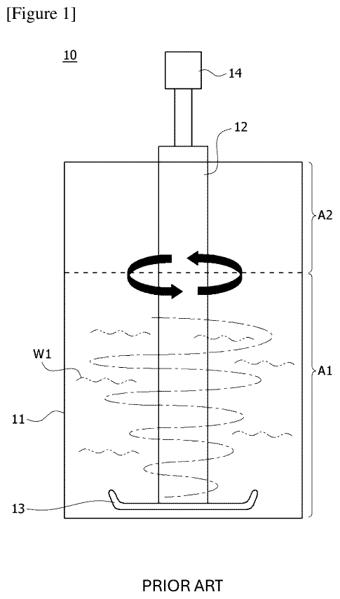

### DETAILED DESCRIPTION

Hereinafter, a stirring device according to one example of the present invention will be described with reference to the accompanying drawings.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

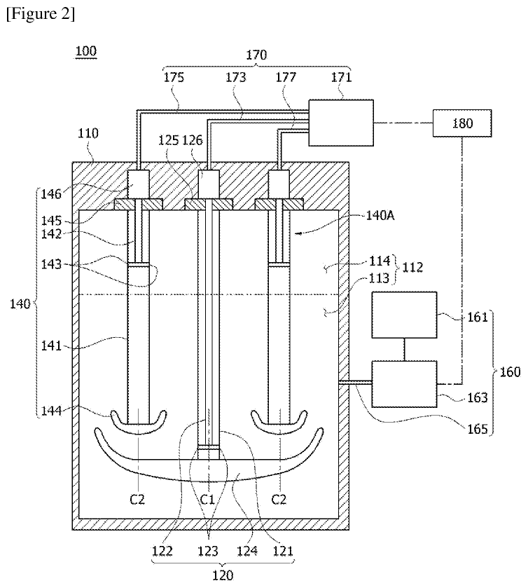

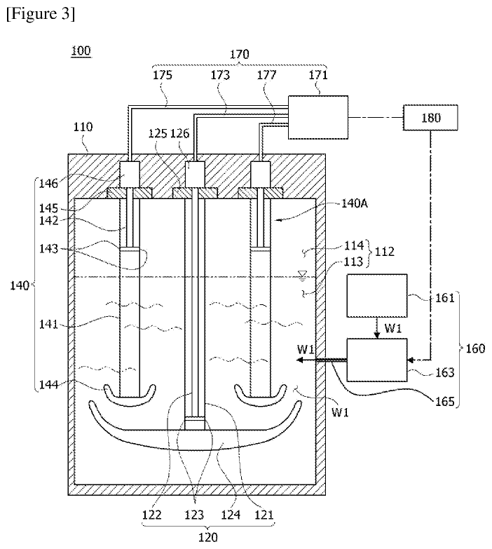

FIG. 2 schematically illustrates a configuration diagram of a stirring device according to one example of the present invention, and FIG. 3 is a diagram for explaining a process in which a cleaning liquid is introduced into a container when a cleaning liquid supply part is operated in one example of the present invention.

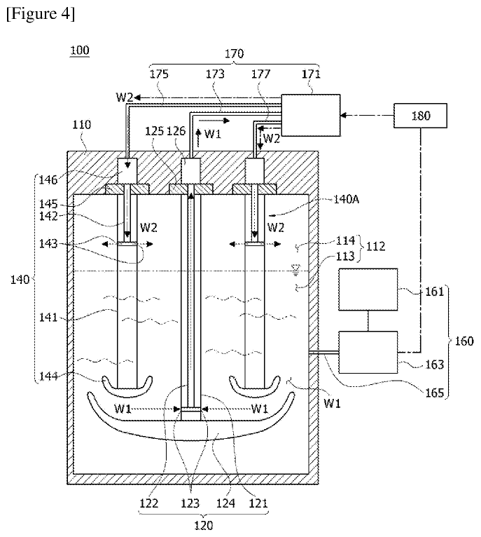

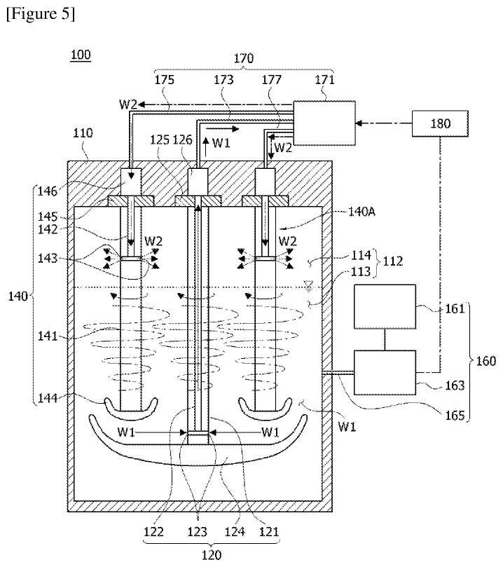

FIG. 4 is a diagram for explaining a flow of a cleaning liquid when a cleaning liquid circulation part operates in one example of the present invention, and FIG. 5 is a diagram for explaining a flow of a cleaning liquid when a cleaning liquid circulation part operates together with first and second stirring parts in one example of the present invention.

A stirring device (100) related to one example of the present invention comprises a container (110) and a cleaning liquid supply part (160) for supplying a cleaning liquid (W1) to the container (110).

Also, the stirring device (100) comprises a first stirring part (120) including a first stirring rod (121) located in the inner space (112) of the container (110), and having a suction passage (122) provided inside the first stirring rod (121) and a plurality of suction ports (123) connecting the suction passage (122) and the inner space (112) of the container (110) in a fluid movable manner and sucking the cleaning liquid (W1) of the inner space (112) of the container.

In addition, the stirring device (100) comprises a second stirring part (140, 140A) including a second stirring rod (141) located in the inner space (112) of the container (110), and having a discharge passage (142) provided inside the second stirring rod (141) and a plurality of discharge ports (143) connecting the discharge passage (142) and the inner space (112) of the container (110) in a fluid movable manner.

Furthermore, the stirring device (100) may also comprise a single second stirring part (140), and may also comprise a plurality of second stirring parts (140, 140A). In the case of comprising a plurality of second stirring parts (140, 140A), the respective second stirring parts (140, 140A) are configured identically, and have only different positions in the container (110).

In addition, the stirring device (100) comprises a cleaning liquid circulation part (170) connected to the suction passage (122) and the discharge passage (142), respectively, and provided to supply the cleaning liquid (W1) introduced through the suction passage (122) to the discharge passage (142).

In the present example, the stirring device (100) is provided to perform a mixing process (also referred to as ‘mixing mode’) of wet-stirring slurry raw materials (not shown) to form a slurry (not shown) and a cleaning process (also referred to as ‘cleaning mode’) of cleaning the container (110).

The cleaning process is performed for cleaning the container (110) after producing a certain amount of slurry (not shown) through the mixing process and before producing another type of slurry (not shown).

Referring to FIG. 2, the stirring device (100) comprises a container (110), a first stirring part (120), second stirring parts (140, 140A), a cleaning liquid supply part (160), a cleaning liquid circulation part (170), and a control part (180). The control part (180) is provided to control the first stirring part (120), the second stirring parts (140, 140A), the cleaning liquid supply part (160), and the cleaning liquid circulation part (170), respectively.

The first and second stirring parts (120, 140, 140A) are provided to stir the contents of the inner space (112) of the container (110). Upon the mixing mode, the first and second stirring parts (120, 140, 140A) stir the slurry raw materials (not shown) in the inner space (112) of the container (110). Upon the cleaning mode of the container (110), the first and second stirring parts (120, 140, 140A) stir the cleaning liquid (W1) in the inner space (112) of the container (110).

In the present example, for convenience of explanation, the inner space (112) of the container (110) is divided into and referred to as an upper space (114) and a lower space (113) based on the height direction of the container. In this document, the height direction of the container (110) means the central axis directions (C1, C2) of the first and second stirring parts (120, 140, 140A).

Here, the lower space (113) is a space that the cleaning liquid (W1) is filled to a certain level through the cleaning liquid supply part (160), which is a space affected by vortexes when the first and second stirring rods (121, 141) rotate.

Here, the upper space (114) is a place located at the top of the lower space (113), which corresponds to a space where the cleaning liquid is not filled through the cleaning liquid supply part (160), and is a space where the influence of the vortexes is not reached upon the rotation of the first and second stirring rods (121, 141).

As shown in FIG. 2, the first stirring part (120) comprises the first stirring rod (121) disposed at the center in the container (110) and having the suction passage (122) and the plurality of suction ports (123).

The suction passage (122) is provided inside the first stirring rod (121). The suction passage (122) is a passage through which the cleaning liquid (W1) introduced from the lower space (113) of the container (110) flows upward of the container (110) when the circulation pump (171) operates.

The suction passage (122) is provided to pass through the central axis (C1) of the first stirring rod (121). This is for preventing the eccentricity of the cleaning liquid (W1) flowing into the suction passage (122) in any one direction when the first stirring rod (121) rotates.

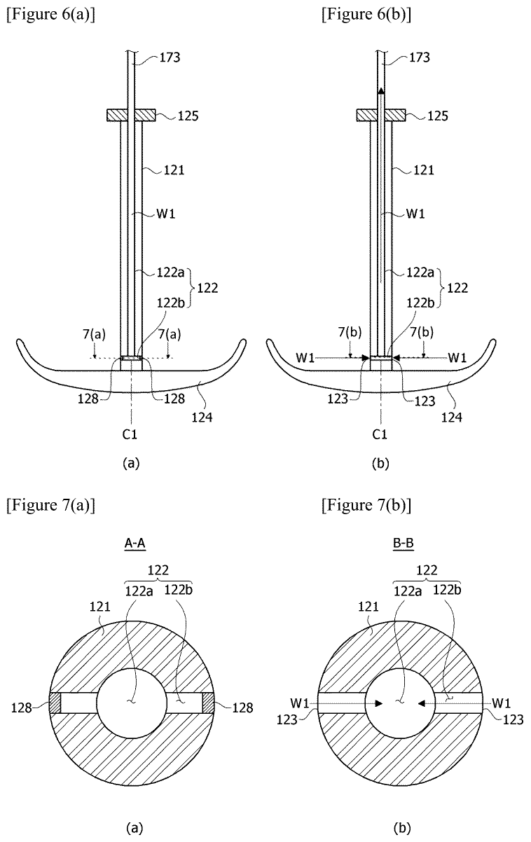

FIG. 6(a) is a cross-sectional diagram of a first stirring part, and FIG. 6(b) is a schematic diagram for explaining a flow of a cleaning liquid flowing through a suction passage in the first stirring part when a cleaning liquid circulation part operates, and FIG. 7(a) is a cross-sectional diagram of 7(a)-7(a) in FIG. 6(a), and FIG. 7(b) is a cross-sectional diagram of 7(b)-7(b) in FIG. 6(a).

Referring to FIGS. 6(a) and 7(a), the suction passage (122) has a recovery line (122a) and a recovery branch line (122b) branched from the recovery line (122a).

The recovery line (122a) is a passage extending along the central axis (C1) direction of the first stirring rod (121). The recovery branch line (122b) is a passage branched from the recovery line (122a) to connect the plurality of suction ports (123).

The plurality of suction ports (123) is provided at the bottom of the first stirring rod (121). The plurality of suction ports (123) is provided to be exposed to the outer surface of the first stirring rod (121). The plurality of suction ports (123) is disposed apart from each other along the circumferential direction of the first stirring rod (121).

The plurality of suction ports (123) is passages through which the cleaning liquid (W1) in the container (110) is sucked, which connect the suction passage (122) and the inner space of the container (110) in a fluid movable manner.

The plurality of suction ports (123) is located at a lower height than the plurality of discharge ports (143) in the inner space (112) of the container (110). This is for allowing the cleaning liquid (W1) in the inner space (112) of the container (110) to more easily flow into the plurality of suction ports (123) when the cleaning liquid circulation part (170) operates.

A valve (128) for opening and closing the plurality of suction ports (123) is further installed in the first stirring rod (121). The valve (128) may be installed on the first stirring rod (121) to open and close the plurality of suction ports (123) at once or individually. The valve (128) may be provided to open the suction port (123) when the circulation pump (171) of the cleaning liquid circulation part (170) operates.

The valve (128) is operated to be opened and closed by the control part (180). Upon the mixing mode, the control part (180) operates the valve (128) to close all the plurality of suction ports (123). The control part (180) operates the valve (128) to open the plurality of suction ports (123) upon the cleaning mode.

In addition, the control part (180) is provided to operate the cleaning liquid circulation part (170) while rotating the first stirring rod (121) and the second stirring rod (141).

At this time, the first stirring rod (121) is rotated at a speed lower than the rotational speed of the second stirring rod (141). That is, the control part (180) may be provided to maintain a rotational speed of the first stirring rod (121) lower than a rotational speed of the second stirring rod (141). The rotational speed of the first stirring rod (121) may be within a range of ⅓ to ⅔ of the maximum rotational speed of the first stirring motor (126).

In addition, as shown in FIG. 2, the first stirring part (120) further comprises a first stirring motor (126) providing rotational force to the first stirring rod (121), a first stirring blade (124) stirring the contents in the container (110) when the first stirring rod (121) rotates, and a first fastening part (125) rotatably coupling the first stirring rod (121) to the top of the container (110). The first fastening part (125) connects the first stirring rod (121) and the suction pipe (173) of the cleaning liquid circulation part (170) in a fluid movable manner.

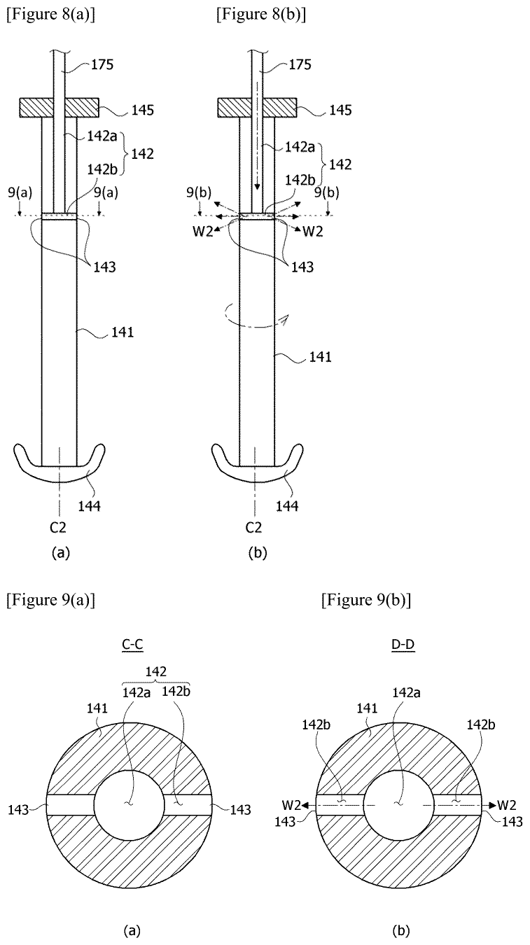

FIG. 8(a) is a cross-sectional diagram of a second stirring part, and FIG. 8(b) is a schematic diagram for explaining a flow of a cleaning liquid flowing through a discharge passage in the second stirring part when a cleaning liquid circulation part operates, and FIG. 9(a) is a cross-sectional diagram of 9(a)-9(a) in FIG. 8(a), and FIG. 9(b) is a cross-sectional diagram of 9(b)-9(b) in FIG. 8(a).

Hereinafter, with reference to FIGS. 2, 8, and 9, the second stirring part (140, 140A) will be described.

The second stirring part (140, 140A) comprises a second stirring rod (141) disposed at an edge in the container (110) to be spaced apart from the first stirring rod (121).

In addition, the second stirring part (140, 140A) further comprises a second stirring motor (146) providing rotational force to the second stirring rod (141), a second stirring blade (144) stirring the contents in the container (110) when the second stirring rod rotates, a second fastening part (145) rotatably coupling the second stirring rod to the top of the container (110). The second fastening part (145) connects the second stirring rod (141) and the discharge pipe (175) of the cleaning liquid circulation part (170) in a fluid movable manner.

One or a plurality of second stirring parts (140, 140A) may be provided. The plurality of second stirring parts (140, 140A) may be disposed apart from each other at the same interval based on the first stirring part (120).

When a pair of second stirring parts (140, 140A) is provided, two discharge pipes of the cleaning liquid circulation part (170) are provided, and at this time, the plurality of discharge pipes (175, 177) may comprise the first discharge pipe (175) and the second discharge pipe (177).

That is, any one of the second stirring parts (140) is connected to the circulation pump (171) by the first discharge pipe (175), and the other second stirring part (140A) is connected to the circulation pump (171) by the second discharge pipe (177).

The plurality of second stirring parts (140, 140A) have the same structure, and thus the description will be made based on one second stirring part (140) in order to avoid repetition of description.

As shown in FIGS. 8(a) and 9(a), the second stirring rod (141) has a discharge passage (142) and a plurality of discharge ports (143).

The discharge passage (142) is provided inside the second stirring rod (141). The discharge passage (142) is a passage through which the cleaning liquid (W1) supplied through the discharge pipe (175) of the cleaning liquid circulation part (170) flows.

The discharge passage (142) is provided to pass through the central axis (C2) of the second stirring rod (141). This is in order that when the second stirring rod (141) rotates, the reuse cleaning liquid (W2) flowing through the discharge passage (142) is evenly sprayed in the circumferential direction of the second stirring rod (141) along a discharge branch line (142b) based on the central axis (C2) of the second stirring rod (141) without being concentrated in any one direction.

The discharge passage (142) has a discharge line (142a) and a discharge branch line (142b) branched from the discharge line (142a). The discharge line (142a) is a passage extending along the central axis (C2) direction of the second stirring rod (141). The discharge branch line (142b) is a passage branched from the discharge line (142a) to connect the plurality of discharge ports (143).

The plurality of discharge ports (143) are passages through which the reuse cleaning liquid (W1) discharged from the discharge passage (142) is discharged to the upper space (114) of the container (110).

The plurality of discharge ports (143) is provided to be exposed to the outer surface of the second stirring rod (141). The plurality of discharge ports (143) is disposed apart from each other along the circumferential direction of the second stirring rod (141).

The plurality of discharge ports (143) is provided at the top of the second stirring rod (141). In addition, the discharge ports (143) are provided to be positioned in the upper space (114) of the container (110). The plurality of discharge ports (143) is located at a higher height than the plurality of suction ports (123) provided on the first stirring rod (121) in the inner space (112) of the container (110).

The respective discharge ports (143) connect the upper space (114) of the container (110) and the discharge passage (142) in a fluid movable manner. As described above, the upper space (114) is a space in which the vortexes do not affect when the first and second stirring rods (121, 141) rotate.

The second stirring part (140) may operate such that the second stirring rod (141) rotates when the cleaning liquid circulation part (170) operates. The second stirring rod (141) rotates at a higher speed than the first stirring rod (121).

Upon the cleaning mode of the container (110), the rotational speed of the second stirring rod (141) may be within a range of ⅓ to ⅔ of the maximum rotational speed of the second stirring motor (146). Upon the cleaning mode of the container (110), the second stirring rod (141) may be rotated at a rotational speed within a range of 20 rpm to 40 rpm. When the second stirring rod (141) rotates, the pressure of the reuse cleaning liquid (W2) discharged through the plurality of discharge ports (143) may be proportional to the rotational speed of the second stirring rod (141).

Referring to FIG. 5, when the second stirring rod (141) rotates, the reuse cleaning liquid (W2) cleans the upper space (114) of the container (110) while being sprayed in the circumferential direction of the second stirring rod (141) through the respective discharge ports (143).

As described above, through the structure change of the first stirring rod (121) and the second stirring rod (141), and the cleaning liquid circulation part (170) connected to the first stirring rod (121) and the second stirring rod (141) to circulate the cleaning liquid, it is also possible to clean the upper space (114), which is not affected by the vortexes when the first and second stirring rods (121, 141) rotate.

Hereinafter, referring to FIGS. 4 and 5, the cleaning liquid circulation part (170) circulating the cleaning liquid (W1) in the container (110) upon the cleaning mode of the container (110) will be described.

The cleaning liquid circulation part (170) is connected to the suction passage (122) of the first stirring rod (121) and the discharge passage (142) of the second stirring rod (141), respectively, and provided to supply the cleaning liquid introduced through the suction passage (122) to the discharge passage (142).

In addition, the cleaning liquid circulation part (170) may comprise a suction pipe (173) connected to the suction passage (122), discharge pipes (175, 177) connected to the discharge passages (142), and a circulation pump (171) connected to the suction pipe (173) and the discharge pipes (175, 177), respectively.

The suction pipe (173) is coupled to the first fastening part (125) to be connected to the suction passage (122) in a fluid movable manner.

The first and second discharge pipes (175, 177) are coupled to the second fastening parts (145) of the second stirring parts (140, 140A) to be connected to the respective discharge passages (142) in a fluid movable manner.

The circulation pump (171) is a pump pressurizing the cleaning liquid (W1) introduced through the suction pipe (173) to discharges it to the first and second discharge pipes (175, 177), respectively. Referring to FIGS. 4 and 5, the circulation pump (171) is operated to suck up the cleaning liquid (W1) in the container (110) upon the cleaning mode of the control part (180).

Referring to FIG. 5, upon the cleaning mode of the container (110), the cleaning liquid circulation part (170) is operated, and the control part (180) is provided to rotate the first stirring part (120) and the second stirring parts (140, 140A), respectively.

Referring to FIGS. 6(b) and 7(b), upon operation of the circulation pump (171), the cleaning liquid (W1) in the inner space (112) of the container (110) flows into the recovery branch line (122b) through the respective suction ports (123). Then, the cleaning liquid (W1) is moved from the recovery branch line (122b) to the top of the first stirring rod (121) along the recovery line (122a). Subsequently, the cleaning liquid (W1) flows into the circulation pump (171) through the suction pipe (173).

The cleaning liquid (W1) is pressurized to a predetermined pressure by the circulation pump (171) to be discharged from the circulation pump (171). The cleaning pressure is in a pressure range of 0.5 bar to 2 bar. When the second stirring rod (141) rotates, the cleaning pressure may be in a pressure range of 0% to 50% of the maximum pressure of the circulation pump (171) in consideration of the rotational force of the second stirring rod (141).

Hereinafter, the cleaning liquid (W1) discharged from the circulation pump (171) to the first and second discharge pipes (175, 177) is referred to as a “reuse cleaning liquid (W2)”.

Referring to FIGS. 8(b) and 9(b), upon operation of the circulation pump (171), the reuse cleaning liquid (W2) is moved in the lower direction of the second stirring rode (141) along the discharge line (142a) of the discharge passage (142), branched into several branches through the discharge branch lines (142b), and then discharged through the respective discharge ports (143).

The reuse cleaning liquid (W2) is discharged from the respective discharge ports (143) to the upper space (114) of the container (110) (see FIG. 4). The reuse cleaning liquid (W2) may clean the upper space (114) of the container (110) while being sprayed in the lateral direction of the second stirring rod (141) by the cleaning pressure.

Alternatively, the reuse cleaning liquid (W2) is sprayed into the upper space (114) of the container (110) in the circumferential direction of the second stirring rod (141) by the centrifugal force of the second stirring rod (141) (see FIG. 5), thereby being capable of cleaning the upper space (114) of the container (110).

Hereinafter, referring to FIG. 3, the cleaning liquid supply part (160) supplying the cleaning liquid (W1) to the inner space (112) of the container (110) before operation of the circulation pump (171) will be described.

Referring to FIG. 3, upon the cleaning mode of the container (110), the cleaning liquid supply part (160) is provided to supply the cleaning liquid (W1) to the container (110). The cleaning liquid supply part (160) comprises a cleaning liquid tank (161), a supply pump (163), and a cleaning liquid supply pipe (165).

The cleaning liquid (W1) is stored in the cleaning liquid tank (161). The supply pump (163) is connected to the cleaning liquid tank (161).

The supply pump (163) supplies the cleaning liquid (W1) in the cleaning liquid tank (161) to the inner space (112) of the container (110). The cleaning liquid supply pipe (165) connects the container (110) and the supply pump (163).

Upon operation of the supply pump (163), the cleaning liquid (W1) is supplied from the cleaning liquid tank (161) to the container (110). The supply pump (163) supplies the cleaning liquid (W1) to the inner space (112) of the container (110) until the cleaning liquid (W1) reaches a certain level in the inner space (112) of the container (110). Here, the certain level is the boundary between the upper space (114) and the lower space (113). The certain level may vary depending on the volume of the container (110). In addition, the input amount of the cleaning liquid (W1) may vary depending on the volume of the container (110).

As shown in FIG. 3, in the cleaning mode of the container (110), the control part (180) supplies the cleaning liquid (W1) into the container (110) at a certain level through the cleaning liquid supply part (160), and then operates the cleaning liquid circulation part (170).

In addition, as shown in FIG. 5, upon the cleaning mode of the container (110), a valve (128) is opened, and the control part (180) operates the circulation pump (171), the first stirring motor (126), and the second stirring motor (146).

That is, when the cleaning liquid (W1) reaches a certain level in the inner space (112) of the container (110), the operation of the supply pump (163) is stopped. Then, the inner space (112) of the container (110) is cleaned while the circulation pump (171), the first stirring motor (126), and the second stirring motor (146) operate.

When the first and second stirring motors (126, 146) are operated, the first and second stirring rods (121, 141) stir the cleaning liquid (W1) in the container (110) while being rotated to form vortexes, thereby cleaning the lower space (113) of the container (110).

At the same time, the circulation pump (171) sucks up the cleaning liquid (W1) in the container (110) through the suction passage (122) of the first stirring rod (121) to discharge it to the discharge passage (142) of the second stirring rod (141). The reuse cleaning liquid (W2) discharged through the discharge passage (142) is sprayed into the upper space (114) of the container (110) to clean the upper space (114) of the container (110).

The preferred example of the present invention as described above has been disclosed for illustrative purposes, and those skilled in the art having ordinary knowledge of the present invention will be able to make various modifications, changes, and additions within the spirit and scope of the present invention, and such modifications, changes, and additions should be regarded as falling within the scope of the following claims.

### INDUSTRIAL APPLICABILITY

According to the stirring device related to at least one example of the present invention, the lower space of the container can be cleaned while the cleaning liquid in the container is stirred, and the upper space of the container can be cleaned while the cleaning liquid in the container is sprayed into the upper space of the container via the cleaning liquid circulation part.

1. A stirring device comprising:
a container;
a cleaning liquid supply part for supplying a cleaning solution to the container;
a first stirring part including a first stirring rod located inside the container, and having a suction passage provided inside the first stirring rod and a plurality of suction ports connecting the suction passage and the inner space of the container in a fluid movable manner and configured to suck the cleaning liquid in the container;
a second stirring part including a second stirring rod located inside the container, and having a discharge passage provided inside the second stirring rod and a plurality of discharge ports connecting the discharge passage and the inner space of the container in a fluid movable manner; and
a cleaning liquid circulation part connected to the suction passage and the discharge passage, respectively, and configured to supply the cleaning liquid introduced through the suction passage to the discharge passage.

2. The stirring device according to claim 1, wherein
the plurality of suction ports is located at a lower height than a height of the plurality of discharge ports in the container.

3. The stirring device according to claim 1, wherein the cleaning liquid circulation part comprises:
a suction pipe connected to the suction passage;
a discharge pipe connected to the discharge passage; and
a circulation pump connected to the suction pipe and the discharge pipe, respectively.

4. The stirring device according to claim 1, wherein
the plurality of suction ports is disposed apart from each other in the circumferential direction of the first stirring rod, and
the suction passage comprises a recovery line connected to a suction pipe of the cleaning liquid circulation part and extending along the central axis direction of the first stirring rod, and a recovery branch line branched from the recovery line to be connected to the plurality of suction ports.

5. The stirring device according to claim 1, wherein
the plurality of discharge ports is disposed apart from each other along the circumferential direction of the second stirring rod, and
the discharge passage comprises a discharge line connected to a discharge pipe of the cleaning liquid circulation part and extending along the central axis direction of the second stirring rod, and a discharge branch line branched from the discharge line to be connected to the plurality of discharge ports.

6. The stirring device according to claim 1, wherein the cleaning liquid supply part comprises:
a cleaning liquid tank in which the cleaning liquid is stored; and
a supply pump supplying the cleaning liquid in the cleaning liquid tank into the container.

7. The stirring device according to claim 1, further comprising
a control part controlling the cleaning liquid supply part, the first and second stirring parts, and the cleaning liquid circulation part, wherein
the control part is configured to supply the cleaning liquid into the container at a predetermined level through the cleaning liquid supply part, and then to operate the cleaning liquid circulation part.

8. The stirring device according to claim 7, wherein
the control part is configured to maintain a rotational speed of the first stirring rod lower than a rotational speed of the second stirring rod.

9. The stirring device according to claim 7, wherein
the control part is configured to operate the cleaning liquid circulation part while rotating the first stirring rod and the second stirring rod.

10. The stirring device according to claim 3, wherein the cleaning liquid circulation part further comprises:
a valve installed on the first stirring rod to open and close the suction ports, where
the valve is configured to open the suction ports upon operation of the circulation pump.

11. A stirring device comprising:
a container;
a cleaning liquid supply part for supplying a cleaning solution to the container;
a first stirring part including a first stirring rod located inside the container, and having a suction passage provided inside the first stirring rod and a plurality of suction ports connecting the suction passage and the inner space of the container in a fluid movable manner and configured to suck the cleaning liquid in the container;
a plurality of second stirring parts each including a second stirring rod located inside the container, and having a discharge passage provided inside the second stirring rod and a plurality of discharge ports connecting the discharge passage and the inner space of the container in a fluid movable manner; and
a cleaning liquid circulation part connected to the suction passage and the discharge passage, respectively, and configured to supply the cleaning liquid introduced through the suction passage to the discharge passage.

12. The stirring device according to claim 11, wherein
the first stirring rod is positioned in the center portion of the container, and
each of the plurality of second stirring rods is disposed apart from the first stirring rod at a same interval.

13. The stirring device according to claim 11, wherein
the plurality of suction ports is located at a lower height than a height of the plurality of discharge ports in the container.

14. The stirring device according to claim 11, wherein the cleaning liquid circulation part comprises:
a suction pipe connected to the suction passage;
a discharge pipe connected to the discharge passage; and
a circulation pump connected to the suction pipe and the discharge pipe, respectively.
